(19) United States
(12) Patent Application Publication
(10) Pub. No.: US 2002/0008639 A1
(43) Pub. Date: Jan. 24, 2002

(54) Parking payment system

(76) Inventor: Mark R. Dee, New Maryland (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/853,094

(22) Filed: May 9, 2001

Related U.S. Application Data
(60) Provisional application No. 60/202,806, filed on May 9, 2000.

(51) Int. Cl. G08G 1/14

(52) U.S. Cl. 340/932.2; 340/988

(57) ABSTRACT

A parking payment system with each user having a communications device to communicate with a central processing center. A reference identifier is located on or within the vehicle to be parked, and a geographical identifier is associated with each parking location and parking space. Parking enforcement personnel each have a wireless ticket issuance device for communicating with the central processing center. Using the user communications device, the user informs the central processing center of a parking space identifier and the user reference identifier. The central processing center is able to communicate with the user communications devices and the wireless ticket issuance devices, and records the time activated by the user for the parking space, counts down the time activated by the user for the vehicle occupying the parking space, and communicates the status of the time activated by the user for the parking space to the wireless ticket issuance device. The reference identifier located with the vehicle can be read by the wireless ticket issuance device and ticket issued if a violation exists. The user communications device can be used to add extra time with respect to the reference identifier when needed.

### CROSS-REFERENCE TO RELATED APPLICATION

This application claims priority from U.S. Provisional Patent Application Serial No. 60/202,806, filed May 9, 2000, which application is hereby incorporated by reference in its entirety.

### FIELD OF THE INVENTION

The present invention relates to a parking payment system to receive payment for parking and enforce parking regulations.

### BACKGROUND OF THE INVENTION

Parking meters in general permit vehicles to be parked along a street for an allowable period of time, which is typically determined by the amount of money inserted therein. A mechanical clockwork or electronic timer inside the parking meter runs down the allowable time until it reaches zero time, and causes an overdue parking indication to appear through a window of the meter. In recent years, parking meters have been improved greatly by the development of low powered electronic circuitry, ultrasonic transmitters and receivers, and wireless communication systems.

Revenues from parking meters are normally used by municipalities to cover the ever-increasing costs of maintaining its infrastructure in a good condition. Therefore the improved modern meters are attractive for a municipality for increasing the revenues generated from its metered parking systems.

Electronic parking meters having these described features are especially attractive to municipalities because all time expiry conditions thereof are readily communicated to parking authority personnel via a central computer. The parking authority personnel may thereby be effectively dispatched to those vehicles in violation of parking regulations, to issue parking tickets to the owners of those vehicles. Such improvement of a metered parking system is known to increase revenues from those meters considerably.

The replacement of a quantity of conventional mechanical meters with newer electronic models represents, nonetheless, a substantial investment of funds for the purchase of the electronic units, an investment of manpower time and wages for replacing the conventional meters by the electronic models, and a financial loss in the writing-off of the undepreciated value of the conventional meters. Therefore, in periods of budget restraint, the acquisition of electronic meters is not economically feasible for many municipalities. This problem is addressed in U.S. Pat. Nos. 5,710,743; 5,903,520 and 5,966,345 which disclose an economical retrofit electronic device to enhance the operation of conventional parking meters as an alternative to an entire replacement of an existing conventional parking meter with a new electronic parking meter.

It is desirable to have a new style parking payment system to make the payment, enforcement and collection of parking revenue more efficient and cost effective. It is desirable to make the system operable without replacing or even upgrading existing meters. The present invention fulfills these needs and further provides related advantages.

### SUMMARY OF THE INVENTION

The present invention resides in a parking payment system which may have several embodiments and include one or more of the following components in addition to a vehicle, a parking space and a parking location:

A user communications means useable by the user, typically the driver or another occupant of the vehicle to be parked in the parking space, to communicate with a central processing means.

A reference identifier located on or within the vehicle.

A geographical identifier belonging with the parking location.

A wireless ticket issuance device used by the parking enforcement personnel for communicating with the central processing means.

The central processing means including at least one microprocessor, with the microprocessor being connectable to a data input subsystem, data output circuitry, data storage circuitry, and a communication interface. The communication interface being capable of communicating with the user communications means and said wireless ticket issuance device.

The microprocessor being connectable to a data input subsystem, data output circuitry, data storage circuitry, and a communication interface. The communication interface being capable of communicating with the user communications means and the wireless ticket issuance device. The microprocessor being programmed with a processing means to record the time activated by the user of the user communications means in the geographical location of the parking space with the reference identifier, count down the time activated by the user for the vehicle occupying the parking space with the user communications means associated with the geographical location and the reference identifier, and communicate the status of the time activated by the user associated with the geographical location and the reference identifier to the wireless ticket issuance device.

The above parking payment system may have the user communications means communicating to the central processing means information that can include the parking space identifier and a municipal identifier of the vehicle occupying the parking space.

The parking payment system may have the user communications means being or including a computer terminal interface, a landline telephone, a mobile phone, a personal data assistant, a paging device. The user communications means may reference the parking location by means of geographic positioning systems.

The parking payment system may use the user communications means to provide the time designated for the reference identifier.

The central processing means of the parking payment system can provide the following information:

The time allotted in the central processing means for the reference identifier as activated by said occupant wireless device.

The location of the parked vehicle as provided by the user communications means.

The status of the time on the reference identifier.

Billing Information for the occupant communications means.

Communication of account information to municipal databases.

The reference identifier of the parking payment can be a reference tag displayed on or within the vehicle. The reference tag may have a bar code designation. The reference identifier can be issued from said central processing means. In one embodiment the reference identifier can be the vehicle's license plate or the vehicle's vehicle identification number.

The central processing means may allow the user to register personal and payment information for the payment of the time activated by the user communications means and stored on the microprocessor. The central processing means can be a computer server which stores reference identifier data strings and parking location data strings belonging to the parking payment system.

The user communications means can add extra time with respect to the reference identifier by updating the central processing means during the time period of the activation of time of the reference identifier. The user communications means of the parking payment system can be notified by the central processing means when the reference identifier's time allotment as first activated by the user communications means is about to expire.

The wireless ticket issuance device used by the parking enforcement personnel can verify the time status of the reference identifier by entering a reference identifier number for the reference identifier or by scanning a bar code with the reference identifier, or by communicating with the reference identifier by wireless communications.

The wireless ticket issuance device used by the parking enforcement personnel can issue and process a ticket to the vehicle in the parking space. The parking enforcement personnel may us the wireless ticket issuance device to issue a ticket if the time was not activated or expired. The microprocessor may be programmed with the processing means to record ticket information received by the wireless ticket issuance device used by the parking enforcement personnel when the time is not valid associated with the geographical location and/or the reference identifier.

The microprocessor may be programmed with the processing means to record account information received by the user for the vehicle occupying the parking space to pay for the time activated by the user. The microprocessor may be programmed with the processing means to credit the parking location accounting system with payment received from the user to pay for the time activated by the user in the parking location.

The microprocessor may be programmed with a processing means to record the time activated by the user of the user communications means in the geographical location with the reference identifier and communicate the status of the time activated by the user to the user communications means associated with the geographical location and the reference identifier.

In one embodiment of the invention, the communication interface may be capable of communicating with the user communications means, the wireless ticket issuance device, and also a parking location accounting system. The microprocessor may be programmed with the processing means to credit the parking location accounting system with payment received by an external party to pay for the time activated by the user of the vehicle occupying the parking space in the parking location. The microprocessor may also be programmed with the processing means to calculate using a mathematical algorithm the price of the time based upon the usage of the parking space in the parking location. The price of the time may be greater or less than a standard price set for the parking space at a particular time.

In another embodiment, the communication interface may be capable of communicating with the user communications means, the wireless ticket issuance device, the parking location accounting system, and a messaging system. The microprocessor may be programmed with the processing means to credit the parking location accounting system with payment received by an external party to pay for the time activated by the user of the vehicle occupying the parking space in the parking location and a processing means to communicate a message to the user about the external party's payment gratuity and potential sales and services.

Yet another embodiment of the parking payment system of the present invention includes a parking meter with a means to transmit, receive and process information. The parking meter is connectable to the data input subsystem, data output circuitry, data storage circuitry, and the communication interface. The communication interface is capable of communicating with the user communications means, the wireless ticket issuance device, and a parking location accounting system. The parking meter is programmed with a processing means to credit the parking location accounting system with payment received by a reference identifier located with the vehicle to credit the parking meter for the time activated by the reference identifier. The communication interface is capable of communicating with the user communications means, the wireless ticket issuance device, the parking location accounting system and the parking meter. The microprocessor may be programmed with the processing means to credit the parking location accounting system with payment received by the parking meter from the reference identifier. The microprocessor may also be programmed with the processing means to credit the parking meter with credit from the user communication means. The microprocessor may also be programmed with the processing means to record the time activated by the reference identifier to the parking meter in the geographical location and communicate the status of the time of the parking meter to the wireless ticket issuance device. The enforcement personnel can issue a ticket with the wireless ticket issuance device if the time was not activated or expired. The microprocessor may further be programmed with the processing means to record the time activated by the reference identifier to the parking meter and communicate the status of the time of the parking meter to the user communication means.

In the embodiment just described, the time designated for the reference identifier may be provided by said the user communication means. Further, the central processing means can provide the following information:

the time allotted in the parking meter,

the location of the parked vehicle as provided by the parking meter,

the status of the time on the parking meter,

billing Information for the reference identifier, and

communication of account information to municipal databases.

In this embodiment of the parking payment system, the reference identifier can be issued from the central processing means. The reference identifier can be a transponder with wireless communications capabilities. The central processing means can allow the occupant to register personal and payment information for the payment of the time activated by the reference identifier and stored on the microprocessor. Further, the central processing means can be a computer server which stores all the said reference identifier data strings and said parking location data strings belonging to said payment system.

Further with respect to this embodiment, the reference identifier has a wireless communication means to update the nearest or relevant the parking meter monitoring its corresponding parking space. The user communications means can communicate with the central processing means to provide the time to the relevant parking meter monitoring its corresponding vehicle in said parking space. The user communication means can add extra time with respect to the parking meter by updating the central processing means during the time period of the activation of time of the parking meter. The user communication means can be notified by said central processing means when said parking meter time allotment as first activated by said reference identifier at said parking meter is about to expire.

In addition, the parking meter can receive a time allotment from the central processing means activated by the user communication means. And finally, the wireless ticket issuance device used by the parking enforcement personnel can issue and process a ticket to the vehicle in the parking space.

Other features and advantages of the invention will become apparent from the following detailed description, taken in conjunction with the accompanying drawings.

### BRIEF DESCRIPTION OF THE DRAWING

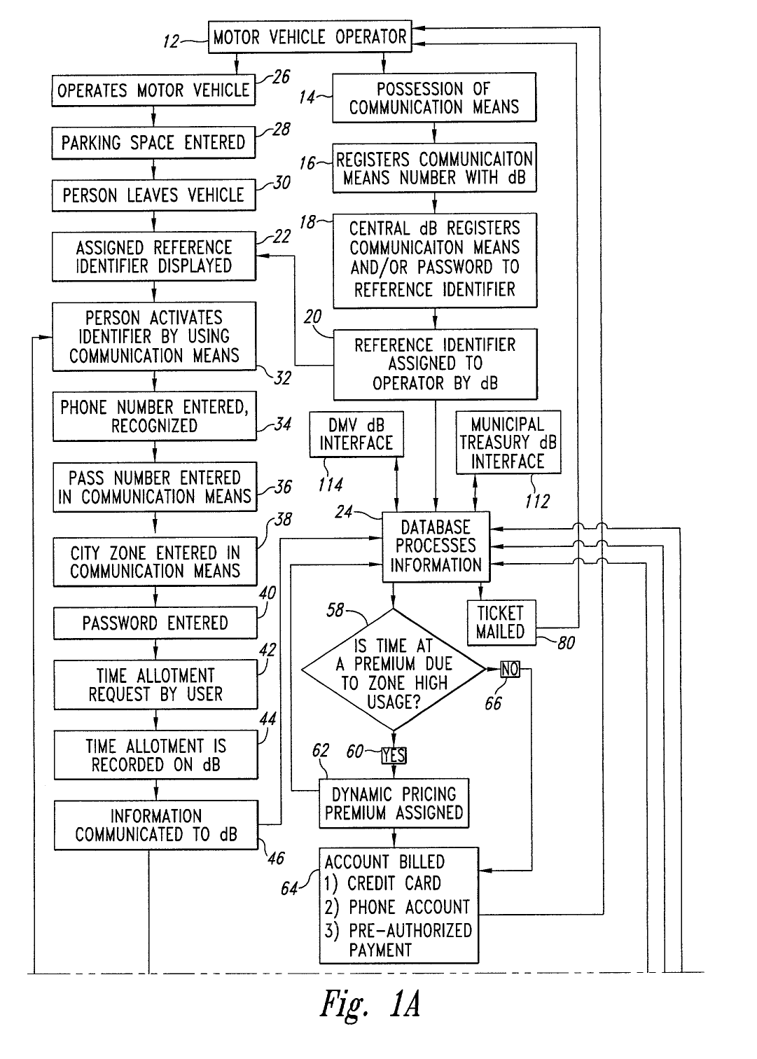

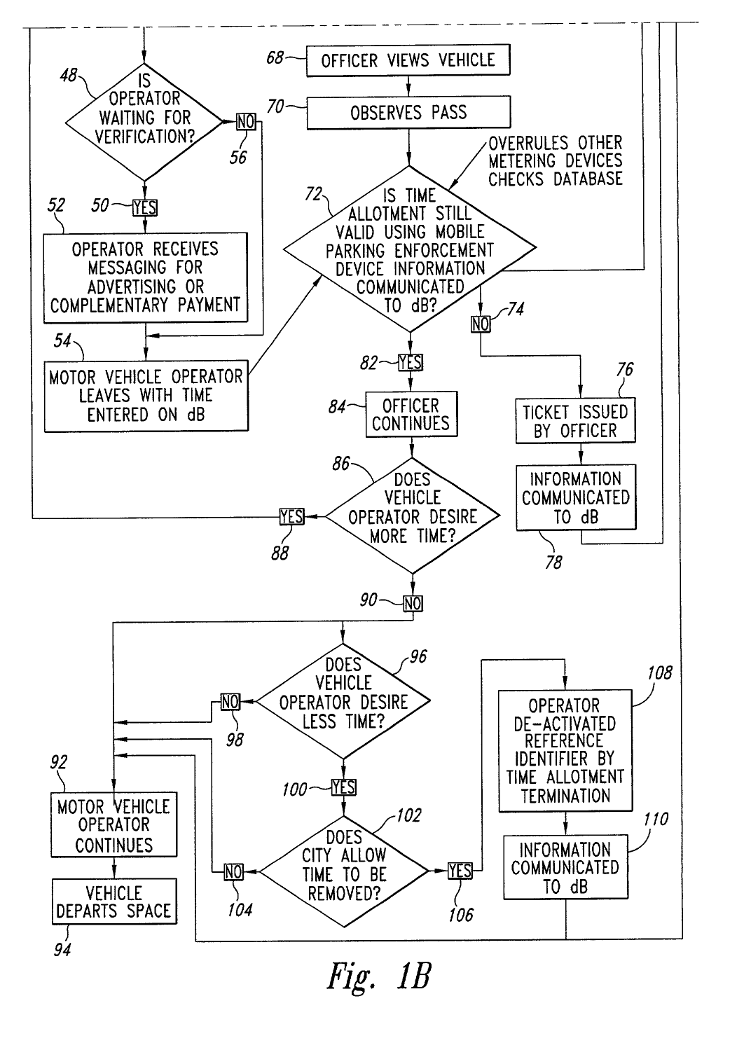

The figure, comprising two parts identified as FIGS. 1A and 1B, is a schematic drawing of one embodiment of the parking payment system of the present invention.

### DETAILED DESCRIPTION OF THE INVENTION

The present invention is embodied in a parking payment system that makes the payment, enforcement and collection of parking revenue more efficient by using a process which entails use of mobile communications devices by users of parking spaces, and parking enforcement personnel communicating with a central billing database.

The parking system allows the users of parking spaces to pay for and locate parking spaces by using communications devices, and referencing the motor vehicle to be using the parking space when making payment via communications to a central processing location with the central billing database. The enforcement of parking regulations by the parking enforcement authority is facilitated by allowing verification that the payment was made for the vehicle in the parking space by using wireless mobile devices communicating with the central processing location. This process allows users a convenient way to pay for parking, without the requirement of hard currency or credit or debit cards at the parking space, and allows users to pay for parking without being present where the vehicle is parked. The process also allows users to override any technologies which may be present at the parking space, and makes parking enforcement personnel aware of this process by their viewing and use of a payment process reference identifier displayed in or on the vehicle.

The system includes, in addition to the parking space and the vehicle, the operator of the vehicle, the reference identifier such as a reference identifier tag displayed on the vehicle that references the vehicle using a reference identifier number, a geographical identifier that references where the vehicle is parked (i.e., a location code), a communications device carried by the operator of the vehicle, and a wireless mobile device used by the parking enforcement personnel when enforcing parking regulations.

Payment for a parking space is completed by the user of the communications device registering payment information, such as credit card or banking information for automatic withdrawal, at the central processing location. The communications device may be enabled with the ability to pre-program the reference identifier number, the location code of the city where the vehicle is parked, and the time requested for paid parking, as well as the space location if required. The communications device may also be pre-programmed to update the account of the user of the communications device by providing banking information to the central billing database. If the communications device does not have pre-programming ability, the user can communicate the time requested for payment and the location code to the central billing database by the prompts from the central billing database to enter the data by a touch pad on the communications device. Payment may also be credited by an external creditor, such as a business that has agreed to pay for users of the system in a geographical location or time period, for a period of time. In such case, the vehicle operator using the system may receive advertising from the creditor when the operator is using the system.

The communications device, may be any standard mobile wireless telephone, but may also be a wireless handheld communications device, a vehicle mounted mobile communications device, or an in-vehicle telematics system with wireless communication capability. The communications device may also be a user's two-way pager or like device, a landline telephone, or a computer connected to a network to access an Internet site. The communications device will include a user interface for communication purposes, incorporating, but not limited to, a selection of one or more of the following:

Display read-out

Alpha-numeric keyboard/keypad (possibly touch screen implemented)

Voice activation or microphone

Audio output or reporting capability

Analog or digital communication capability battery, mains or vehicle power

The central billing database may be connected to an Internet site. The central billing database records the phone number and assigns the reference identifier number to a phone number. The user of the phone number also submits billing information so that when the time is activated, the billing is recorded against the appropriate payment means. The central billing database also has the ability through an Application Programmers Interface or other database connections to retrieve time payments by credit card or automatic bank account withdrawal. The central billing database receives payment and then credits an appropriate city location treasury database account.

Once billing and phone number information has been received and verified by the central billing database, the reference identifier, which can be displayed in any vehicle, is issued to the user of the communications device. This reference identifier becomes active for a designated period of time in the central billing database when the reference identifier is displayed in the vehicle of the user of the communications device and when the user of the communications device contacts the central billing database and requests that the reference identifier be activated in the central billing database for a period of time in a particular geographic location (i.e., a city). The geographic location is referenced by the geographical identifier number, which may be a sign with an alphanumeric code displayed, with each specific location code belonging to an assigned city or location. The time activated can be instantaneously granted for a designated period of time when the central billing database is activated by the communications device or reserved for a future period of time when the user knows the reference identifier will be monitored by parking enforcement personnel. The designated time period may only be activated by the user for a fixed period of time as determined by the by-laws and/or parking regulations of a given municipality. The user, upon return to the vehicle within the designated period of time, may communicate with the central billing location to deactivate the time to be charged to the user's account. The central billing database with processing means may also use a mathematical algorithm to obtain a rate to charge for parking in the geographical location based upon the usage and density of parking in the geographical location. This algorithm may calculate that the parking rates are higher during peak hours of usage such as during the day, and thus set the rates higher than the standard rates used by the municipality.

This reference identifier may be displayed on the window or other visible location of the vehicle and may include a bar code strip. The reference identifier may also reference the vehicle's license plate number or Vehicle Identification Number (VIN).

The reference identifier is a device providing unique identification of the vehicle, owner or user of the system for someone, or an entity registered to access and utilize the system. The reference identifier can be a visual reference such as the reference identifier tag, or a radio frequency or wireless identifier. For example, the reference identifier could take the following forms:

Visual reference identifier capable of being placed, adhered to, hung or mounted otherwise, in or on a vehicle, such that it is visible from outside of the vehicle, e.g., the reference identifier tag.

Radio frequency or wireless reference identifier capable of communicating from within or on a vehicle to a person or device wishing to interrogate the reference identifier by a compatible means.

The reference identifier may also contain a bar code or other remote readable device to facilitate information transfer to a qualified “reader” (person or thing) of the reference identifier.

The user of the communications device need not be present at the vehicle to endorse time against the reference identifier. The parking enforcement personnel, with a wireless mobile device such as a wireless handheld device, can verify if the vehicle is parked in accordance with the municipal bylaws and/or parking regulations. If the parking enforcement personnel identifies the reference identifier, the parking enforcement personnel can verify at that instant in time, if the reference identifier has been activated in the database for a designated period of time, which corresponds to the time that the parking enforcement personnel is checking the reference identifier via wireless communications with the same central billing database at the central processing location. If the reference identifier is determined to be valid for the time in question, the parking enforcement personnel moves on to the next vehicle, even though the vehicle for which the query was made may be parked in a parking space that has an alternate means of parking payment, such as a parking meter, which has not been paid, since payment for the time has been made via the parking payment system of the present invention.

The wireless mobile device used by the parking enforcement personnel is programmed to communicate with the central billing database to transmit the reference identifier number and a time stamp of when the parking enforcement personnel officer is making the query. The time stamp of the parking enforcement personnel is checked against the time allotment paid in the central billing database. The wireless mobile device is also a fully functional ticket issuance device that can perform the process of issuing a parking ticket and update the database which interfaces with ticket processing software, and can also perform other queries to other databases to gain information on vehicle license plates or other owner information. The wireless mobile device can also be equipped with a bar code scanner for ease of reading the reference identifier if in the form of a bar code, or with a camera that can image reference identifiers to send the image to the central processing location. The wireless mobile device can enter information on a pre-programmed enforcement user interface for efficient use.

The wireless mobile device used by the parking enforcement personnel may take the form of a communications device, a mobile computing unit or some other wireless communication device, and may be handheld or otherwise. The wireless mobile device will include the user interface for communication purposes, incorporating, but not limited to, a selection of one or more of the following:

Display read-out

Alpha-numeric keyboard/keypad (possibly touch screen implemented)

Voice activation or microphone

Audio output or reporting capability

Analog or digital communication capability battery, mains or vehicle power

Bar code scanner

The central billing location is aware of the city location of the vehicle and sends payment for the designated time to the city where the user has paid for such time. The parking enforcement personnel with the wireless mobile device identifies the reference identifier and checks to verify the time via wireless communications, and if the central processing location via wireless return communications informs the parking enforcement personnel that the designated time has not been activated or the time has passed, then the parking enforcement personnel can issue a parking citation for the vehicle. The parking citation information can then be communicated automatically to the central processing location with billing information for ease of citation payment collection. The system also allows for persons who have recurring parking citations to access the central billing database via communications or the Internet to pay the citations using these technologies to provide for a convenient way to pay parking citations and other parking infractions.

Another feature of the parking payment system of the present invention is that upon the expiration of the designated time for a vehicle's reference identifier active in the central billing database, the central billing database, through communications means, can inform the user of the reference identifier that the designated time has expired and request if more time is desired by the user. This prompt allows the user to add more time to the reference identifier so the vehicle will not be in a violation state.

Some newer parking meters have been developed with two-way wireless communications. The parking payment system of the present invention allows the user of the communications device, through the central processing location, to not only add funds to the reference identifier time allotment in the central billing database, but also to add time to a wireless parking meter. This is accomplished through a process where the central billing location, or the reference identifier that may be a radio frequency device, sends a time signal to the parking meter, which has been identified by the user of the communications device, to cause time to be added to the parking meter in an amount designated by the user of the communications device. The parking meter can then communicate to the parking enforcement personnel when the designated time has expired via wireless communications.

The reference identifier may also include a local radio frequency capabilities that allows the parking enforcement personnel to pass in close proximity to the parked vehicle to verify the reference identifier, without having to physically enter the reference identifier on their wireless handheld device. The reference identifier may be used for other tolling applications. This process can also be accomplished by mobile license plate recognition where the parking enforcement personnel moves in a vehicle and scans the parked vehicles with license plate recognition technologies to verify the reference identifiers.

An embodiment of the parking payment system of the present invention is illustrated in the functional flow chart in the Figure. A motor vehicle operator or user of the system, represented by block 12, is in possession of a communication device or means 14 with a communication means number. In block 16, the user registers the communication means number with the central processing center and the communication means number is placed in the central billing database. The communication means number and/or a password stored in the central billing database is referenced to a reference identifier in block 18. The reference identifier may be a reference identifier number (e.g., a “pass” number). In block 20, the reference identifier is assigned to the user by the central billing database. As discussed above and indicated in the Figure in block 22, the assigned reference identifier is displayed on or within the vehicle. As also discussed above and shown in the Figure in block 24, the assigned reference identifier is used by the central billing database to process information.

The operation of the parking payment system when parking the vehicle is also shown in the Figure. In block 26, the user operates the motor vehicle. In block 28, the vehicle is parked in a parking space. The user can then leave the car in the parking space as indicated in block 30 with the assigned reference identifier displayed in or on the vehicle as indicated in block 22. The user activates the reference identifier in the central billing database to pay for parking the vehicle in the parking space by using the communication means (see block 14) as indicated in block 32. This involves the user entering the telephone number for the central processing center in the communication means and the number being recognized in block 34. The “pass” number for the reference identifier is entered into the communication means in block 36. In block 38 the city zone where the parking is taking place is entered into the communication means. A password is entered into the communication means in block 40, and a time allotment requested by the user to pay for parking the vehicle in the parking is also entered into the communication means in block 42 (e.g., 15 minutes or 1 hour). All of this data is sent by the communication means to the central billing database and the time allotment request is recorded there as indicated in blocks 44 and 46.

The user can wait for a verification from the central billing database on the information sent to the central billing database. As indicated in blocks 48 and 50, if the user is waiting for a verification, the user may receive messaging for advertising or a complementary payment as indicated in block 52. As indicated in blocks 48 and 56, the user may elect not to wait for a verification. In either situation, the vehicle is in the parking space with the requested time allotment entered into the central billing database for payment for the parking and also in case a parking enforcement personnel should check to see if the parking has been paid for by the user.

Upon return to the vehicle within the requested time allotment or within an increased time allotment requested by the user as will be discussed below, the user may communicate with the central billing location to deactivate the time to be charged to the user's account and leave the parking space with the vehicle, as indicated in block 54. This may affect the amount charged the user for parking the vehicle in the parking space.

The amount to be charged the user for the time parked in the parking space is determined by the central processing center. As described above, the parking payment system may use a mathematical algorithm to obtain a variable rate to charge for parking in the parking space based upon the time of day, and/or usage and density of parking in the geographical location of the parking space. As indicated in block 58, the parking payment system makes a decision whether the vehicle is parked during a time period when a premium parking rate is to be charged. If yes (see block 60), in block 62 a dynamic pricing premium is assigned and the amount the user is to be charged for parking the vehicle in the parking space is determined. In block 64 that amount is billed to the credit card, phone account, or pre-authorized payment method selected by the user for payment of parking charges. Other methods of payment can be used. If the vehicle is not parked during a time period when a premium parking rate is to be charged as indicated by block 66, a standard rate is used to determine the amount the user is to be charged for parking the vehicle in the parking space and that amount is billed to the credit card, phone account, or pre-authorized payment method selected by the user for payment of parking charges, or some other method of payment is utilized.

Of course, as sometimes happens, the user may fail to remove the vehicle from the parking space within the requested time allotment or within an increased time allotment requested by the user, and a parking enforcement personnel may happen upon the vehicle, as indicated in block 68. If no conventional parking metering device is present at the parking space or if one is present and not showing that the parking has been paid using the parking metering device (e.g., a coin operated parking meter is present at the parking space not activated by coins and thus in a violation condition), the parking enforcement personnel will look to determine if a reference identifier is displayed on or in the vehicle. As indicated in block 70, if the parking enforcement personnel observes a reference identifier (such as a “pass” number), the parking enforcement personnel will check with the central billing database to determine if the parking is paid for using the parking payment system of the present invention and not in a violation condition.

As indicated in block 72, using the wireless mobile device carried by the parking enforcement personnel, the parking enforcement personnel will communicate with the central billing database to determination if the reference identifier has been activated for parking of the vehicle in the parking space and if the requested time allotment and any increased time allotment requested by the user is still active (i.e., the time allotment has been not been exceeded and thus no violation exists). If the time allotment is not valid (i.e., a parking violation exists), the answer is no and the parking enforcement personnel will issue a ticket, as indicated in blocks 74 and 76. The parking enforcement personnel uses the wireless mobile device carried by the parking enforcement personnel to communicate information about the ticket issued to the central billing database as indicated in block 78. The central billing database processes this information (see block 24) and mails a ticket to the user for the violation as indicated in block 80.

If when the parking enforcement personnel communicates with the central billing database to determination if the reference identifier has been activated for parking of the vehicle in the parking space and if the requested time allotment and any increased time allotment requested by the user is still active, the time allotment is determined to be valid (i.e., no parking violation exists), so the answer is yes to the determination in block 72,as indicated in block 82. The parking enforcement personnel may then continue as indicated in blocks 84 and 86 to determine if the user desires more time by communicating with the user if the user happens to be present. Also, the central processing center may be programmed to initiate a communication with the user via the user's communications device when the time allotment for the referenced identifier is about to expire. If the user responds yes (i.e., more time is desired), as indicated in block 88, the user repeats the process starting at about block 32 to request an increased time allotment for the parking space. Alternatively, the user may on his own or at some other prompting request an increased time allotment.

If the user responds no, as indicated in block 90, to an inquiry or prompting concerning requesting more time, the user may continue and eventually cause the vehicle to depart the parking space, as indicated in blocks 92 and 94.

If prior to the expiration of the requested time allotment and any increased time allotment requested by the user, the user may desire to decrease the time allotment (and thus not be charged for the full time allotment), as indicated in block 96. If the user does not desire to do so, as indicated in block 98, the answer is no and the user may continue and eventually cause the vehicle to depart the parking space, as indicated in blocks 92 and 94. If, however, the user does desire to decrease the time allotment, as indicated in blocks 96 and 100, it must be determined by the parking payment system if the city allows time to be removed, as indicated in block 102. If not, as indicated in block 104, the user may continue and eventually cause the vehicle to depart the parking space, as indicated in blocks 92 and 94. If the city does allow time to be removed from the time allotment as indicated in block 106, the user can de-activate the reference identifier before the time allotment terminates and communicate this to the central billing database using the communication device carried by the user, as indicated in blocks 108 and 110. The central billing database processes this information (see block 24) and makes an appropriate adjustment to the amount to be charged the user for parking the vehicle in the parking space.

It is noted that an interface with the central billing database is provided, as indicated in block 112, for communications with the city treasury to payment of the amounts charged users for parking in the city parking spaces. Another interface is provided, as indicated in block 114, for communications with the department of motor vehicles (DMV) of the appropriate governmental body if needed to provide parking infraction information or other information.

It is noted that while the parking payment system is described as using a central system, such as the central processing center with the central billing database, a distributed system may be used. Also, while the central billing data base is described as being a database, other manners of storing and processing information may be used.

As described above, the parking payment system of the present invention is useful to eliminate /minimize capital infrastructure required to receive payment according to parking regulations and to facilitate the enforcement of those parking regulations. The parking payment system may include in one embodiment the following components in addition to a vehicle, a parking space and a parking location:

A user communications means useable by the user, typically the driver or another occupant of the vehicle to be parked in the parking space, to communicate with a central processing means.

A reference identifier located on or within the vehicle.

A geographical identifier belonging with the parking location.

A wireless ticket issuance device used by the parking enforcement personnel for communicating with the central processing means.

The central processing means including at least one microprocessor, with the microprocessor being connectable to a data input subsystem, data output circuitry, data storage circuitry, and a communication interface. The communication interface being capable of communicating with the user communications means and said wireless ticket issuance device.

The microprocessor being connectable to a data input subsystem, data output circuitry, data storage circuitry, and a communication interface. The communication interface being capable of communicating with the user communications means and the wireless ticket issuance device. The microprocessor being programmed with a processing means to record the time activated by the user of the user communications means in the geographical location of the parking space with the reference identifier, count down the time activated by the user for the vehicle occupying the parking space with the user communications means associated with the geographical location and the reference identifier, and communicate the status of the time activated by the user associated with the geographical location and the reference identifier to the wireless ticket issuance device.

The parking payment system of the present invention, in various embodiments, may include one or more of the designs, constructions, and/or modes of operation set forth below and briefly discussed:

The above parking payment system may have the user communications means communicating to the central processing means information that can include the parking space identifier and a municipal identifier of the vehicle occupying the parking space.

The parking payment system may have the user communications means being or including a computer terminal interface, a landline telephone, a mobile phone, a personal data assistant, a paging device, or any radio frequency device. The user communications means may reference the parking location by means of geographic positioning systems.

The parking payment system may use the user communications means to provide the time designated for the reference identifier.

The central processing means of the parking payment system can provide the following information:

The time allotted in the central processing means for the reference identifier as activated by said occupant wireless device.

The location of the parked vehicle as provided by the user communications means.

The status of the time on the reference identifier.

Billing Information for the occupant communications means.

Communication of account information to municipal databases.

The reference identifier of the parking payment can be a reference tag displayed on or within the vehicle. The reference tag may have a bar code or smart label designation. The reference identifier can be issued from said central processing means. In one embodiment the reference identifier can be the vehicle's license plate or the vehicle's vehicle identification number.

The central processing means may allow the user to register personal and payment information for the payment of the time activated by the user communications means and stored on the microprocessor. The central processing means can be a computer server which stores reference identifier data strings and parking location data strings belonging to the parking payment system.

The user communications means can add extra time with respect to the reference identifier by updating the central processing means during the time period of the activation of time of the reference identifier. The user communications means of the parking payment system can be notified by the central processing means when the reference identifier's time allotment as first activated by the user communications means is about to expire.

The wireless ticket issuance device used by the parking enforcement personnel can verify the time status of the reference identifier by entering a reference identifier number for the reference identifier or by scanning a bar code with the reference identifier, or by communicating with the reference identifier by wireless communications.

The wireless ticket issuance device used by the parking enforcement personnel can issue and process a ticket to the vehicle in the parking space. The parking enforcement personnel may use the wireless ticket issuance device to issue a ticket if the time was not activated or expired. The microprocessor may be programmed with the processing means to record ticket information received by the wireless ticket issuance device used by the parking enforcement personnel when the time is not valid associated with the geographical location and/or the reference identifier.

The microprocessor may be programmed with the processing means to record account information received by the user for the vehicle occupying the parking space to pay for the time activated by the user. The microprocessor may be programmed with the processing means to credit the parking location accounting system with payment received from the user to pay for the time activated by the user in the parking location.

The microprocessor may be programmed with a processing means to record the time activated by the user of the user communications means in the geographical location with the reference identifier and communicate the status of the time activated by the user to the user communications means associated with the geographical location and the reference identifier.

The communication interface may be capable of communicating with the user communications means, the wireless ticket issuance device, and also a parking location accounting system. The microprocessor may be programmed with the processing means to credit the parking location accounting system with payment received by an external party to pay for the time activated by the user of the vehicle occupying the parking space in the parking location. The microprocessor may also be programmed with the processing means to calculate using a mathematical algorithm the price of the time based upon the usage of the parking space in the parking location. The price of the time may be greater or less than a standard price set for the parking space at a particular time.

The communication interface may be capable of communicating with the user communications means, the wireless ticket issuance device, the parking location accounting system, and a messaging system. The microprocessor may be programmed with the processing means to credit the parking location accounting system with payment received by an external party to pay for the time activated by the user of the vehicle occupying the parking space in the parking location and a processing means to communicate a message to the user about the external party's payment gratuity and potential sales and services.

One embodiment of the parking payment system of the present invention includes a parking meter with a means to transmit, receive and process information. The parking meter is connectable to the data input subsystem, data output circuitry, data storage circuitry, and the communication interface. The communication interface is capable of communicating with the user communications means, the wireless ticket issuance device, and a parking location accounting system. The parking meter is programmed with a processing means to credit the parking location accounting system with payment received by a reference identifier located with the vehicle to credit the parking meter for the time activated by the reference identifier. The communication interface is capable of communicating with the user communications means, the wireless ticket issuance device, the parking location accounting system and the parking meter. The microprocessor may be programmed with the processing means to credit the parking location accounting system with payment received by the parking meter from the reference identifier. The microprocessor may also be programmed with the processing means to credit the parking meter with credit from the user communication means. The microprocessor may also be programmed with the processing means to record the time activated by the reference identifier to the parking meter in the geographical location and communicate the status of the time of the parking meter to the wireless ticket issuance device. The enforcement personnel can issue a ticket with the wireless ticket issuance device if the time was not activated or expired. The microprocessor may further be programmed with the processing means to record the time activated by the reference identifier to the parking meter and communicate the status of the time of the parking meter to the user communication means.

In the embodiment just described, the time designated for the reference identifier may be provided by said the user communication means. Further, the central processing means can provide the following information:

the time allotted in the parking meter,

the location of the parked vehicle as provided by the parking meter,

the status of the time on the parking meter, billing Information for the reference identifier, and

communication of account information to municipal databases.

In this embodiment of the parking payment system, the reference identifier can be issued from the central processing means. The reference identifier can be a transponder with wireless communications capabilities. The central processing means can allow the occupant to register personal and payment information for the payment of the time activated by the reference identifier and stored on the microprocessor. Further, the central processing means can be a computer server which stores all the said reference identifier data strings and said parking location data strings belonging to said payment system.

Further with respect to this embodiment, the reference identifier has a wireless communication means to update the nearest or relevant the parking meter monitoring its corresponding parking space. The user communications means can communicate with the central processing means or the parking meter to provide the time to the relevant parking meter monitoring its corresponding vehicle in said parking space. The user communication means can add extra time with respect to the parking meter by updating the central processing means or the parking meter during the time period of the activation of time of the parking meter. The user communication means can be notified by said central processing means when said parking meter time allotment as first activated by said reference identifier at said parking meter is about to expire.

In addition, the parking meter can receive a time allotment from the central processing means activated by the user communication means. And finally, the wireless ticket issuance device used by the parking enforcement personnel can issue and process a ticket to the vehicle in the parking space.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A payment system to eliminate /minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle
A geographical identifier belonging with said parking location
A wireless ticket issuance device used by enforcement personnel communicating to a central processing means
Said central processing means including at least one microprocessor, said microprocessor being connectable to a data input subsystem, data output circuitry, data storage circuitry, and a communication interface, said communication interface being capable of communicating with said occupant communications means and said wireless ticket issuance device.
Said microprocessor being connectable to a data input subsystem, data output circuitry, data storage circuitry, and a communication interface, said communication interface being capable of communicating with said occupant communications device said enforcement communications device, said microprocessor being programmed with a processing means to record the time activated by user of said occupant communications device in said geographical location with said reference identifier and count down said time activated by said occupant of said parking space with said communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device.

2. The payment system of claim 1 where said occupant communication means communicates to said central processing means information that can include said parking space identifier and said municipal identifier of said occupant said vehicle.

3. The payment system of claim 1 where said occupant communication means can be a computer terminal interface.

4. The payment system of claim 1 where said occupant communication means can be a landline telephone.

5. The payment system of claim 1 where said occupant communication means said parking location can be referenced by means of geographic positioning systems.

6. The payment system of claim 1 where said occupant communication means can include a mobile phone.

7. The payment system of claim 1 where said occupant communication means can include a personal data assistant.

8. The payment system of claim 1 where said occupant communication means can include a paging device.

9. The payment system of claim 1 where said time designated for said reference identifier is provided by said occupant communication means.

10. The payment system of claim 1 where said central processing means can provide the following information
The said time allotted in said central processing means said reference identifier as activated by said occupant wireless device
The location of said parked vehicle as provided by said occupant communication means
The status of said time on said reference identifier
Billing Information for said occupant communications means
Communication of account information to municipal databases

11. The payment system of claim 1 where said reference identifier can be a reference tag displayed on said vehicle.

12. The payment system of claim 1 where said reference identifier can be issued from said central processing means.

13. The payment system of claim 1 where said reference identifier can be a reference tag with a bar code designation.

14. The payment system of claim 1 where said reference identifier can be the vehicle's license plate.

15. The payment system of claim 1 where said reference identifier can be the said vehicle's vehicle identification number.

16. The payment system of claim 1 where said central processing means allows said occupant to register personal and payment information for the payment of said time activated by occupant communication means and stored on said microprocessor.

17. The payment system of claim 1 where said central processing means can be a computer server which stores all the said reference identifier data strings and said parking location data strings belonging to said payment system.

18. The payment system of claim 1 where said occupant communication means can add extra time with respect to said reference identifier by updating said central processing means during the time period of the activation of time of said reference device.

19. The payment system of claim 1 where said occupant communication means can be notified by said central processing means when said reference identifiers time allotment as first activated by said occupant wireless issuance device is about to expire.

20. The payment system of claim 1 where said wireless ticket issuance device used by said enforcement personnel can verify the time status of said reference identifier by entering the reference identifier number.

21. The payment system of claim 1 where said wireless ticket issuance device used by said enforcement personnel can verify the time status of said reference identifier by scanning a bar code.

22. The payment system of claim 1 where said wireless ticket issuance device used by said enforcement personnel can verify the time status by communicating with the said reference identifier by wireless communications.

23. The payment system of claim 1 where said communication means used by said enforcement personnel can issue and process a ticket to said vehicle in said parking space.

24. A payment system to eliminate /minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle
A geographical identifier belonging with said parking location
A wireless ticket issuance device used by enforcement personnel communicating to a central processing means
Said central processing means including at least one microprocessor, said microprocessor being connectable to a data input subsystem, data output circuitry, data storage circuitry, and a communication interface, said communication interface being capable of communicating with said occupant communications means and said wireless ticket issuance device.
Said microprocessor being connectable to a data input subsystem, data output circuitry, data storage circuitry, and a communication interface, said communication interface being capable of communicating with said occupant communications device said enforcement communications device, said microprocessor being programmed with a processing means to record the time activated by user of said occupant communications device in said geographical location with said reference identifier and count down said time activated by said occupant of said parking space with said communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device.
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device, said enforcement personnel can issue a ticket with said wireless ticket issuance device if said time was not activated or expired
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record ticket information received by said wireless ticket issuance device used by said enforcement personnel when said time is not valid associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record account information received by said occupant of said parking space to pay for said time activated by said occupant.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to credit said parking location accounting system with payment received by said occupant of said parking space to pay for said time activated by said occupant in said parking location.

25. The payment system of claim 24 where said occupant communication means communicates to said central processing means information that can include said parking space identifier and said municipal identifier of said occupant said vehicle.

26. The payment system of claim 24 where said occupant communication means can be a computer terminal interface.

27. The payment system of claim 24 where said occupant communication means can be a landline telephone.

28. The payment system of claim 24 where said occupant communication means said parking location can be referenced by means of geographic positioning systems.

29. The payment system of claim 24 where said occupant communication means can include a mobile phone.

30. The payment system of claim 24 where said occupant communication means can include a personal data assistant.

31. The payment system of claim 24 where said occupant communication means can include a paging device.

32. The payment system of claim 24 where said time designated for said reference identifier is provided by said occupant communication means.

33. The payment system of claim 24 where said central processing means can provide the following information
The said time allotted in said central processing means said reference identifier as activated by said occupant wireless device
The location of said parked vehicle as provided by said occupant communication means
The status of said time on said reference identifier
Billing Information for said occupant communications means
Communication of account information to municipal databases

34. The payment system of claim 24 where said reference identifier can be a reference tag displayed on said vehicle.

35. The payment system of claim 24 where said reference identifier can be issued from said central processing means.

36. The payment system of claim 24 where said reference identifier can be a reference tag with a bar code designation.

37. The payment system of claim 24 where said reference identifier can be the vehicle's license plate.

38. The payment system of claim 24 where said reference identifier can be the said vehicle's vehicle identification number.

39. The payment system of claim 24 where said central processing means allows said occupant to register personal and payment information for the payment of said time activated by occupant communication means and stored on said microprocessor.

40. The payment system of claim 24 where said central processing means can be a computer server which stores all the said reference identifier data strings and said parking location data strings belonging to said payment system

41. The payment system of claim 24 where said occupant communication means can add extra time with respect to said reference identifier by updating said central processing means during the time period of the activation of time of said reference device.

42. The payment system of claim 24 where said occupant communication means can be notified by said central processing means when said reference identifiers time allotment as first activated by said occupant communication means is about to expire.

43. The payment system of claim 24 where said wireless ticket issuance device used by enforcement personnel can verify the time status of said reference identifier by entering the reference identifier number.

44. The payment system of claim 24 where said wireless ticket issuance device used by enforcement personnel can verify the time status of said reference identifier by scanning a bar code.

45. The payment system of claim 24 where said wireless ticket issuance device used by enforcement personnel can verify the time status by communicating with the said reference identifier by wireless communications.

46. The payment system of claim 24 where said wireless ticket issuance device used by enforcement personnel can issue and process a ticket to said vehicle in said parking space.

47. A payment system to eliminate/minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle
A geographical identifier belonging with said parking location
A wireless ticket issuance device used by enforcement personnel communicating to a central processing means
Said central processing means including at least one microprocessor, said microprocessor being connectable to a data input subsystem, data output circuitry, data storage circuitry, and a communication interface, said communication interface being capable of communicating with said occupant communications means and said wireless ticket issuance device.
Said microprocessor being connectable to a data input subsystem, data output circuitry, data storage circuitry, and a communication interface, said communication interface being capable of communicating with said occupant communications device said enforcement communications device, said microprocessor being programmed with a processing means to record the time activated by user of said occupant communications device in said geographical location with said reference identifier and count down said time activated by said occupant of said parking space with said communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device.
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device, said enforcement personnel can issue a ticket with said wireless ticket issuance device if said time was not activated or expired
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record ticket information received by said wireless ticket issuance device used by said enforcement personnel when said time is not valid associated with said geographical location and said reference identifier.
Said microprocessor being connectable to a data input subsystem, data output circuitry, data storage circuitry, and a communication interface, said communication interface being capable of communicating with said occupant communications means said wireless ticket issuance device, said microprocessor being programmed with a processing means to record the time activated by user of said occupant communications means in said geographical location with said reference identifier and communicate the status of said time activated by said occupant to said occupant communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record account information received by said occupant of said parking space to pay for said time activated by said occupant.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to credit said parking location accounting system with payment received by said occupant of said parking space to pay for said time activated by said occupant in said parking location.

48. A payment system to eliminate /minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle
A geographical identifier belonging with said parking location
A wireless ticket issuance device used by enforcement personnel communicating to a central processing means
Said central processing means including at least one microprocessor, said microprocessor being connectable to a data input subsystem, data output circuitry, data storage circuitry, and a communication interface, said communication interface being capable of communicating with said occupant communications means, said wireless ticket issuance device, said parking location accounting system.
Said microprocessor being connectable to a data input subsystem, data output circuitry, data storage circuitry, and a communication interface, said communication interface being capable of communicating with said occupant communications means said wireless ticket issuance device, and said parking location accounting system, said microprocessor being programmed with a processing means to credit said parking location accounting system with payment received by a external party to pay for said time activated by said occupant of said parking space in said parking location.
Said microprocessor being connectable to a data input subsystem, data output circuitry, data storage circuitry, and a communication interface, said communication interface being capable of communicating with said occupant communications device said enforcement communications device, said microprocessor being programmed with a processing means to record the time activated by user of said occupant communications device in said geographical location with said reference identifier and count down said time activated by said occupant of said parking space with said communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device.
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device, said enforcement personnel can issue a ticket with said wireless ticket issuance device if said time was not activated or expired
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record ticket information received by said wireless ticket issuance device used by said enforcement personnel when said time is not valid associated with said geographical location and said reference identifier.
Said microprocessor being connectable to a data input subsystem, data output circuitry, data storage circuitry, and a communication interface, said communication interface being capable of communicating with said occupant communications means said wireless ticket issuance device, and said parking location accounting system, said microprocessor being programmed with a processing means to calculate using a mathematical algorithm the price of said time based upon the usage of said parking space in said parking location, the said price of said time may be greater or less than the standard price set for said parking space at a particular time.

49. A payment system to eliminate/minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle
A geographical identifier belonging with said parking location
A wireless ticket issuance device used by enforcement personnel communicating to a central processing means
Said central processing means including at least one microprocessor, said microprocessor being connectable to a data input subsystem, data output circuitry, data storage circuitry, and a communication interface, said communication interface being capable of communicating with said occupant communications means, said wireless ticket issuance device, said parking location accounting system and a messaging system.
Said microprocessor being connectable to a data input subsystem, data output circuitry, data storage circuitry, and a communication interface, said communication interface being capable of communicating with said occupant communications device said enforcement communications device, said microprocessor being programmed with a processing means to record the time activated by user of said occupant communications device in said geographical location with said reference identifier and count down said time activated by said occupant of said parking space with said communications means associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device.
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by user of said occupant communications device in said geographical location with said reference identifier and communicate the status of said time activated by said occupant associated with said geographical location and said reference identifier to said wireless ticket issuance device, said enforcement personnel can issue a ticket with said wireless ticket issuance device if said time was not activated or expired
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record ticket information received by said wireless ticket issuance device used by said enforcement personnel when said time is not valid associated with said geographical location and said reference identifier.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record account information received by said occupant of said parking space to pay for said time activated by said occupant.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to credit said parking location accounting system with payment received by said occupant of said parking space to pay for said time activated by said occupant in said parking location.
Said microprocessor being connectable to a data input subsystem, data output circuitry, data storage circuitry, and a communication interface, said communication interface being capable of communicating with said occupant communications means said wireless ticket issuance device, said parking location accounting system, and said messaging system said microprocessor being programmed with a processing means to credit said parking location accounting system with payment received by a external party to pay for said time activated by said occupant of said parking space in said parking location and a processing means to communicate a message to said occupant about said external parties payment gratuity and potential sales and services.
Said microprocessor being connectable to a data input subsystem, data output circuitry, data storage circuitry, and a communication interface, said communication interface being capable of communicating with said occupant communications means said wireless ticket issuance device, and said parking location accounting system, said microprocessor being programmed with a processing means to calculate using a mathematical algorithm the price of said time based upon the usage of said parking space in said parking location, the said price of said time may be greater or less than the standard price set for said parking space at a particular time.

50. A payment system to eliminate /minimize capital infrastructure required to enforce and receive payment of said regulations and to facilitate the enforcement of parking regulations, said system comprising the following components in addition to a vehicle, a parking space and a parking location:
A communications means used by the said occupant of said vehicle of said parking space communicates to a central processing means.
A reference identifier located with said vehicle that has a communication means.
A wireless ticket issuance device used by enforcement personnel communicating to a central processing means
A parking meter with a means to transmit, receive and process information.
Said parking meter being connectable to a data input subsystem, data output circuitry, data storage circuitry, and a communication interface, said communication interface being capable of communicating with said occupant communications means said wireless ticket issuance device, and said parking location accounting system, said parking meter being programmed with a processing means to credit said parking location accounting system with payment received by said reference identifier located with said vehicle that has a communications means to credit said parking meter for said time activated by said reference identifier of said parking space in said parking location.
Said central processing means including at least one microprocessor, said microprocessor being connectable to a data input subsystem, data output circuitry, data storage circuitry, and a communication interface, said communication interface being capable of communicating with said occupant communications means, said wireless ticket issuance device, said parking location accounting system and said parking meter.
Said microprocessor being connectable to a data input subsystem, data output circuitry, data storage circuitry, and a communication interface, said communication interface being capable of communicating with said occupant communications means said wireless ticket issuance device, and said parking location accounting system, said microprocessor being programmed with a processing means to credit said parking location accounting system with payment received by said parking meter from said reference identifier.
Said microprocessor being connectable to a data input subsystem, data output circuitry, data storage circuitry, and a communication interface, said communication interface being capable of communicating with said occupant communications means said wireless ticket issuance device, and said parking location accounting system, said microprocessor being programmed with a processing means to credit said parking meter with credit from said occupant communication means.
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by said reference identifier to said parking meter in said geographical location and communicate the status of said time of said parking meter to said wireless ticket issuance device, said enforcement personnel can issue a ticket with said wireless ticket issuance device if said time was not activated or expired
Said microprocessor being connectable to a data input subsystem, data output circuitry, data storage circuitry, and a communication interface, said communication interface being capable of communicating with said occupant communication means said wireless ticket issuance device, said microprocessor being programmed with a processing means to record the time activated by said reference identifier to said parking meter and communicate the status of said time of said parking meter to said occupant communication means.
Said microprocessor being connectable to a data input subsystem, data output circuitry, data storage circuitry, and a communication interface, said communication interface being capable of communicating with said occupant communications means and said wireless ticket issuance device, said microprocessor being programmed with a processing means to record ticket information received by said wireless ticket issuance device used by said enforcement personnel when said time is not valid associated with said geographical location and said reference identifier.

51. The payment system of claim 50 where said occupant communication means can be a computer terminal interface.

52. The payment system of claim 50 where said occupant communication means can be a landline telephone.

53. The payment system of claim 50 where said occupant communication means can include a mobile phone.

54. The payment system of claim 50 where said occupant communication means can include a personal data assistant.

55. The payment system of claim 50 where said occupant communication means can include a paging device.

56. The payment system of claim 50 where said time designated for said reference identifier is provided by said occupant communication means.

57. The payment system of claim 50 where said central processing means can provide the following information
The said time allotted in said parking meter
The location of said parked vehicle as provided by said parking meter
The status of said time on said parking meter
Billing Information for said reference identifier
Communication of account information to municipal databases

58. The payment system of claim 50 where said reference identifier can be issued from said central processing means.

59. The payment system of claim 50 where said reference identifier can be a radio frequency transponder with wireless communications capabilities.

60. The payment system of claim 50 where said central processing means allows said occupant to register personal and payment information for the payment of said time activated by said reference identifier and stored on said microprocessor.

61. The payment system of claim 50 where said central processing means can be a computer server which stores all the said reference identifier data strings and said parking location data strings belonging to said payment system

62. The payment system of claim 50 where said reference identifier has a wireless communication means to update the nearest or relevant said parking meter monitoring its corresponding said parking space.

63. The payment system of claim 50 where said occupant communications means can communicate to the central processing means to provide said time to relevant said parking meter monitoring its corresponding said vehicle in said parking space.

64. The payment system of claim 50 where said occupant communication means can add extra time with respect to said parking meter by updating said central processing means during the time period of the activation of time of said parking meter.

65. The payment system of claim 50 where said occupant communication means can be notified by said central processing means when said parking meter time allotment as first activated by said reference identifier at said parking meter is about to expire.

66. The payment system of claim 50 where said vehicle said parking meter can be receive a time allotment from said central processing means activated by said occupant communication means.

67. The payment system of claim 50 where said wireless ticket issuance device used by said enforcement personnel can issue and process a ticket to said vehicle in said parking space.

68. The payment system of claim 50 where said reference identifier can be a mobile phone.

69. The payment system of claim 50 where said reference identifier can be a personal data assistant.
